(19) United States
(12) Patent Application Publication
(10) Pub. No.: US 2012/0164054 A1
(43) Pub. Date: Jun. 28, 2012

(54) Impurity Reducing Process and Purified Material

(75) Inventor: Nathan G. Stoddard, Gettysburg, PA (US)

(73) Assignee: BP Corporation North America Inc., Naperville, IL (US)

(21) Appl. No.: 13/143,552

(22) PCT Filed: Jan. 6, 2010
(86) PCT No.: PCT/US10/20179

§ 371 Date: Jul. 7, 2011

Related U.S. Application Data
(60) Provisional application No. 61/143,177, filed on Jan. 8, 2009.

(51) Int. Cl. C01B 33/037; C01B 33/02

(52) U.S. Cl. 423/348

(57) ABSTRACT

This invention relates to a process for reducing impurities, such as contaminants in silicon suitable for use in solar cells or solar modules. The process includes the step of melting a feedstock with impurities and the step of adding an impurity-removing agent to the feedstock. The process also includes the step of reacting the impurities with the impurity-removing agent to form a high-temperature solid, and the step of separating the high-temperature solid from the feedstock.

This application claims the benefit of priority from U.S. Provisional Patent Application No. 61/143,177, filed Jan. 8, 2009, the entirety of which is expressly incorporated herein by reference.

### BACKGROUND

1. Technical Field

This invention relates to a process for reducing impurities, such as contaminants in silicon suitable for use in solar cells or solar modules.

2. Discussion of Related Art

Processes to upgrade silicon by reducing impurities include at least four known techniques: vacuum (and e-beam) evaporation, acid leaching, slag treatment, and directional solidification/segregation. The vacuum evaporation technique is expensive, very rate limited, and time consuming. The acid leaching technique is a wet process relying on the porosity of the silicon with a difficult rinsing step and a difficult drying step. No known slag treatment is effective to remove phosphorus from silicon. The directional solidification/segregation technique is process intensive since two of the key impurities segregate only weakly during directional solidification necessitating repeated refinements with a poor net yield of silicon to bring the impurity concentration down.

The above techniques leave a desire to reduce impurities in silicon by a more efficient manner and minimize loss of usable silicon compared with known processes. There is also a desire to remove impurities with a low segregation coefficient from the silicon, as well as to cost effectively refine lower grade silicon or metallurgical grade silicon to at least solar grade silicon. Finally, there is a desire to produce solar cells and/or solar modules from more pure silicon resulting in a greater efficiency.

### SUMMARY

This invention relates to a process for reducing impurities, such as contaminants in silicon suitable for use in solar cells or solar modules. The invention includes a metallurgical treatment for the removal of impurities from silicon. This invention includes a process to reduce impurities in silicon by a more efficient manner and minimizes loss of usable silicon compared with known techniques. This invention also includes a process to remove impurities with a low segregation coefficient from the silicon. This invention also includes a process to cost effectively refine lower grade silicon or metallurgical grade silicon to at least solar grade silicon. This invention also includes a process to produce solar cells and/or solar modules from more pure silicon resulting in a greater efficiency.

According to a first embodiment, this invention includes a process for reducing impurities in silicon suitable for use in solar cells or solar modules. The process includes the step of melting a feedstock with impurities and the step of adding an impurity-removing agent to the feedstock. The process also includes the step of reacting the impurities with the impurity-removing agent to form a high-temperature solid, and the step of separating the high-temperature solid from the feedstock.

According to a second embodiment, this invention includes a process for reducing impurities in silicon suitable for use in solar cells or solar modules. The process includes the step of melting a feedstock with impurities and the step of reacting the impurities with an impurity-removing agent to form a high-temperature solid. The process also includes the step of separating the high-temperature solid from the feedstock, wherein the high-temperature solid has a solid/liquid segregation coefficient at least about 2 times more effective than the impurity.

According to a third embodiment, this invention includes a process for reducing impurities in silicon suitable for use in solar cells or solar modules. The process includes the step of melting silicon with about 10 parts per million atomic (ppma) of phosphorous, and the step of adding about 1,000 parts per million atomic of gallium to the silicon. The process also includes the step of reacting the phosphorous with the gallium to form gallium phosphide, and the step of separating the gallium phosphide from at least a portion of the silicon. The process also includes the step of solidifying the silicon and the step of remelting the silicon. The process also includes the step of reducing a content of the gallium in the feedstock, optionally combined with a further step of resolidifying the silicon.

According to a fourth embodiment, this invention includes a silicon ingot or purified silicon made by any of the steps and/or processes disclosed herein.

### DETAILED DESCRIPTION

This invention relates to a process for reducing impurities, such as contaminants in silicon suitable for use in solar cells or solar modules. This invention may allow for the efficient removal of impurities, including phosphorus, from metallurgical silicon as part of a conversion to solar grade silicon.

According to one embodiment, the invention includes the use of gallium in a treatment step for molten silicon, such as to remove and/or reduce phosphorus. Phosphorous segregates only weakly from silicon during directional solidification (segregation coefficient of 0.35). The process includes addition of a suitable quantity of gallium, such as up to about 1,000 parts per million atomic (ppma). The gallium can be added to a batch of liquid silicon and then left to treat the molten silicon over some period of time. It is a desirable property of gallium that it has a strong bond to phosphorus and forms a high-temperature solid, such as gallium phosphide (GaP). Gallium phosphide includes a low solubility in silicon and a higher density than molten silicon. Gallium phosphide has a density of 4.13 grams per cubic centimeter and molten silicon has a density of 2.33 grams per cubic centimeter.

During the treatment phase, a slag layer (either floating or preferably sinking) may be beneficially used as a separation layer for the high-temperature solid, allowing the high-temperature solid to escape the silicon. Without the slag layer, the process relies on gravitational separation of the denser GaP, such as gathering or collecting on the bottom. Convection currents or circulation in the liquid may help the high-temperature solid reaction proceed. The process may also be performed iteratively, with one or more slags or slag layers being formed and then removed from the melt in order to maximize the partitioning efficiency and optimize equilibrium constraints. Additional gallium may be added during subsequent processing steps.

Still referring to the same embodiment, the resulting silicon may include excess gallium introduced into the silicon. Once the phosphorus has been removed with the high-temperature solid, separation of the excess gallium proceeds more favorably than phosphorous removal. Gallium segregates at a much higher efficiency (around 0.008), and will tend to come out of the silicon (phase separation leading to concentration in the liquid) during the subsequent directional solidification steps used to decrease the metals content of the silicon. A small amount of residual gallium is actually desirable, since it will tend to counter-dope residual phosphorus, especially towards the end of directional solidification, for example. The net reaction of the high-temperature solid and subsequent removal can result in a high yield with an efficient removal of phosphorus and minimal collateral impurity introduction.

The gallium may be added in any suitable amount and/or form. The gallium may be added in elemental form or may be added as a compound. The gallium may be added as a solid, a liquid, a gas, and/or the like. According to one embodiment, the gallium includes 99.9 percent purity on an atomic or a molar basis.

Moreover, although casting of silicon has been described herein, other semiconductor materials and nonmetallic crystalline materials may be purified without departing from the scope and spirit of the invention. For example, the inventors have contemplated purifying or refining other materials consistent with embodiments of the invention, such as germanium, gallium arsenide, silicon germanium, aluminum oxide (including its sapphire crystalline form), gallium nitride, zinc oxide, zinc sulfide, gallium indium arsenide, indium antimonide, germanium, yttrium barium oxides, lanthanide oxides, magnesium oxide, calcium oxide, and other semiconductors, oxides, and intermetallics with a liquid phase. In addition, a number of other group III-V or group II-VI materials, as well as metals and alloys, could be processed according to embodiments of the present invention.

Processed silicon in its liquid form can be solidified in or into any suitable form, including amorphous silicon, multicrystalline silicon, near multicrystalline silicon, geometric multicrystalline silicon, polycrystalline silicon, and/or monocrystalline silicon. Multicrystalline silicon refers to crystalline silicon having about a centimeter scale grain size distribution, with multiple randomly oriented crystals located within a body of multicrystalline silicon.

Geometric multicrystalline silicon or geometrically ordered multicrystalline silicon refers to crystalline silicon having a nonrandom ordered centimeter scale grain size distribution, with multiple ordered crystals located within a body of multicrystalline silicon. The geometric multicrystalline silicon may include grains typically having an average about 0.5 centimeters to about 5 centimeters in size and a grain orientation within a body of geometric multicrystalline silicon can be controlled according to predetermined orientations, such as using a combination of suitable seed crystals.

Polycrystalline silicon refers to crystalline silicon with micrometer to millimeter scale grain size and multiple grain orientations located within a given body of crystalline silicon. Polycrystalline silicon may include grains typically having an average of about submicron to about micron in size (e.g., individual grains are not visible to the naked eye) and a grain orientation distributed randomly throughout.

Monocrystalline silicon refers to crystalline silicon with very few grain boundaries since the material has generally and/or substantially the same crystal orientation. Monocrystalline silicon material may be formed with one or more seed crystals, such as a piece of crystalline material brought in contact with liquid silicon during directional solidification to set the crystal growth. Near monocrystalline silicon refers to generally crystalline silicon with more grain boundaries than monocrystalline silicon but generally substantially fewer than multicrystalline silicon.

According to one embodiment, this invention may include a process for reducing impurities in silicon suitable for use in solar cells or solar modules. The process may include the step of melting a feedstock with impurities, and the step of adding an impurity-removing agent to the feedstock. The process may also include the step of reacting the impurities with the impurity-removing agent to form a high-temperature solid, and the step of separating the high-temperature solid from the feedstock.

Process broadly refers to any suitable combination and/or sequence of steps and/or sub-steps to accomplish or complete a desired outcome or task. Solar cells broadly refer to any suitable device and/or mechanism for capturing and/or converting at least a portion of the electromagnetic spectrum into a different type of energy, such as electricity. Solar modules broadly refer to any suitable devices including solar cells and suitable mounting or framing, such as for installation on a roof top.

Impurities broadly refer to elements and/or compounds that are not pure, elemental silicon. The impurities may reduce an efficiency of the solar cell and/or solar module, such as boron, phosphorous, tin, iron, oxygen, carbon, nitrogen, and/or the like. The feedstock may include any suitable amount or concentration of the impurity, such as between about 1 part per million atomic and about 500 parts per million atomic, between about 5 parts per million atomic and about 50 parts per million atomic, about 10 parts per million atomic, and/or the like.

Feedstock broadly refers to any suitable material, such as for use in solar cells and/or solar modules. Feedstock may include metallurgical grade silicon, solar grade silicon, semiconductor grade silicon, and/or the like. The feedstock may be in a solid form and/or a molten form. The feedstock may include random chunks or pieces. In the alternative, the feedstock may include sized and/or classified material, such as processed through size reduction equipment, grinders, hammer mills, screeners, and/or the like. The feedstock may be granulated, pelletized, pulverized, and/or the like.

Melting broadly refers to raising an internal energy or temperature of a substance or material to or above a melting point, where the substance no longer remains substantially in a solid phase. Desirably, melting results in the feedstock becoming at least substantially liquid. According to one embodiment, the melting point of the feedstock includes at least about 1,350 degrees Celsius, at least about 1,400 degrees Celsius, at least about 1,412 degrees Celsius, at least about 1,420 degrees Celsius, and/or the like.

Optionally, melting may include providing additional heat or temperature above the melting point, such as to result in superheated material. Any amount of superheat may be used, such as at least about 5 degrees Celsius, at least about 10 degrees Celsius, at least about 25 degrees Celsius, and/or the like.

Adding broadly refers to combining, contacting, mixing and/or the like. Impurity-removing agent broadly refers to any suitable element and/or compound to assist or aid in reducing and/or removing impurities from the feedstock. According to one embodiment, the impurity-removing agent includes gallium.

The addition of the impurity-removing agent may include any suitable amount and/or ratio of the impurity-removing agent to the impurity, such as at least about 0.25 parts per million atomic of the impurity-removing agent to each part per million atomic of the impurity (0.25:1), at least about 0.50 parts per million atomic of the impurity-removing agent to each part per million atomic of the impurity (0.5:1), at least abut 1.0 parts per million atomic of the impurity-removing agent to each part per million atomic of the impurity (1:1), at least about 2.0 parts per million atomic of the impurity-removing agent to each part per million atomic of the impurity (2:1), at least about 5.0 parts per million atomic of the impurity-removing agent to each part per million atomic of the impurity (5:1), at least about 25 parts per million atomic of the impurity-removing agent to each part per million atomic of the impurity (25:1), at least about 50 parts per million atomic of the impurity-removing agent to each part per million atomic of the impurity (50:1), at least about 100 parts per million atomic of the impurity-removing agent to each part per million atomic of the impurity (100:1), at least about 500 parts per million atomic of the impurity-removing agent to each part per million atomic of the impurity (500:1), at least about 1,000 parts per million atomic of the impurity-removing agent to each part per million atomic of the impurity (1,000:1), and/or the like.

In the alternative, the impurity-removing agent includes between about 1 part per million atomic and about 100,000 parts per million atomic of a mixture of the feedstock and the impurity-removing agent, between about 10 parts per million atomic and about 10,000 parts per million atomic of a mixture of the feedstock and the impurity-removing agent, about 1,000 parts per million atomic of a mixture of the feedstock and the impurity-removing agent and/or the like.

Reacting broadly refers to any suitable chemical reaction including formation, removal, and/or rearrangement of bonds, such as covalent bonds, ionic bonds, hydrogen boding, van der waals forces, and/or the like. High-temperature solid broadly refers to any suitable substance having a melting point above the melting point of the feedstock. According to one embodiment, the high-temperature solid includes gallium phosphide with a melting point of 1,480 degrees Celsius. The high-temperature solid may include any suitable melting point, such as a melting point at least about 10 degrees Celsius greater than a melting point of the feedstock, at least about 25 degrees Celsius greater than a melting point of the feedstock, at least about 50 degrees Celsius greater than a melting point of the feedstock, at least about 100 degrees Celsius greater than a melting point of the feedstock, and/or the like.

The phase difference between the molten (liquid) feedstock and the high-temperature solid desirably, aids or assists in separation and/or purification. Desirably, but not necessarily, the separation of the high-temperature solid may be further assisted or aided by a density difference and/or a density-based liquid separation. The density difference may be any suitable amount, such as the high-temperature solid and the molten feedstock have a density ratio of at least about 1:1, at least about 1.25:1, about least about 1.5:1, at least about 1.75:1, at least about 2:1, and/or the like. Density may be measured by any suitable method and/or units, such as mass over volumetric displacement, preferably in grams per cubic centimeter.

The process may further include the step of mixing the feedstock and the impurity-removing agent. Mixing broadly refers to combining, contacting, and/or the like. Mixing may be accomplished or completed by any suitable manner, such as by bubbling an inert gas through the molten feedstock, stirring mechanically with an agitator, stirring magnetically with a stir bar, agitating electromagnetically with current flowing through a nearby coil, and/or the like.

According to one embodiment, the process may include the step of adding a slag-forming agent. Slag-forming agent broadly refers to an element or compound for forming a slag. Slag broadly refers to scoria and/or dross, such as from melting the feedstock. Desirably, the slag helps to control impurity levels in the molten feedstock. The slag-forming agent may include any suitable substance, such as silicon dioxide, and/or the like. The slag-forming agent and/or the resultant slag may sink or float in the feedstock, such as depending upon the materials chosen. Optionally, the slag-forming agent helps to control or reduce impurity-removing agent levels in the molten feedstock. The slag-forming agent may help to collect and/or concentrate the high-temperature solid from the silicon.

According to one embodiment, the process may include the step of reducing a content of the impurity-removing agent in the feedstock, such as by directional solidification, refining, smelting, and/or the like. Solidification broadly refers to lowering an internal energy and/or temperature of a material to or below the freezing point, such as substantially not a liquid phase. Desirably, solidification results in a solid phase. Solidification may also include any suitable amount of subcooling, such as at least about 10 degrees Celsius below the freezing point, at least about 50 degrees Celsius below the freezing point, at least about 100 degrees Celsius below the freezing point, about ambient conditions, and/or the like.

Directional solidification broadly refers to removing or extracting heat and/or temperature from one or more surfaces of the vessel or crucible containing the feedstock, such as a bottom, sides, a top, and/or the like.

According to one embodiment, the process may include the step of solidifying the feedstock during and/or after separating the high-temperature solid. The process may also include the step of remelting (melting again) the feedstock, the step of removing or reducing a content of the impurity-removing agent in the feedstock, and the step of resolidifying (solidifying again) the feedstock using directional solidification and separating a last-to-freeze material from a remaining portion, such as by decanting or pouring off while molten, by breaking or sawing apart after solidified, and/or the like.

A ratio of the impurities in the feedstock (before reducing impurities) to impurities in a purified feedstock (after reducing impurities) may include any suitable number, such as at least about 1.5:1, at least about 2:0, at least about 3:1, at least about 5:1, at least about 10:1, at least about 25:1, at least about 50:1, at least about 100:1, at least about 500:1, at least about 1,000:1, and/or the like.

The feedstock may include any suitable mass, such as at least about 100 kilograms, at least about 200 kilograms, at least about 300 kilograms, at least about 400 kilograms, at least about 500 kilograms, at least about 750 kilograms, at least about 1,000 kilograms, and/or the like.

A mass of purified feedstock and or ingot may include any suitable amount, such as at least about 50 percent of a mass of the feedstock with impurities, at least about 60 percent of a mass of the feedstock with impurities, at least about 70 percent of a mass of the feedstock with impurities, at least about 75 percent of a mass of the feedstock with impurities, at least about 80 percent of a mass of the feedstock with impurities, at least about 85 percent of a mass of the feedstock with impurities, at least about 90 percent of a mass of the feedstock with impurities, at least about 95 percent of a mass of the feedstock with impurities, and/or the like.

Segregation coefficient broadly refers to a number representing in thermodynamic equilibrium a relation between a concentration of impurity atoms in a growing crystal and that of a melt. The segregation coefficient ranges from greater than zero (0) to unity (1.0) and is a dimensionless number. Materials or impurities with smaller segregation coefficients (near zero) separate more easily from the feedstock. Materials or impurities with larger segregation coefficients (near unity) can be more difficult to separate from the feedstock or prefer to remain in the feedstock during directional solidification.

A ratio of segregation coefficients of the impurity to the impurity-removing agent may include any suitable value or range, such as at least about 5:1, at least about 10:1, at least about 15:1, at least about 20:1, at least about 25:1, at least about 35:1, at least about 50:1, at least about 100:1, at least about 500:1, and/or the like.

Desirably, the segregation coefficient of the high-temperature solid is less than the impurity sought to be removed, such as to facilitate or aid in reducing or removing the impurity. Also desirably, the segregation coefficient of the impurity-removing agent is less than the impurity sought to be removed, such as to facilitate or aid in reducing or removing excess impurity-removing agent after the impurity has been reduced or removed.

The impurity-removing agent may include any suitable segregation coefficient, such at less than about 0.5, less than about 0.4, less than about 0.3, less than about 0.25, less than about 0.2, less than about 0.15, less than about 0.1, less than about 0.05, less than about 0.01, less than about 0.005, less than about 0.001, and/or the like.

The high-temperature solid may include any suitable segregation coefficient, such at less than about 0.5, less than about 0.4, less than about 0.3, less than about 0.25, less than about 0.2, less than about 0.15, less than about 0.1, less than about 0.05, less than about 0.01, less than about 0.005, less than about 0.001, and/or the like.

The high-temperature solid may include a segregation coefficient of any suitable amount more effective than the impurity, such as at least about 2 times more effective than the impurity, at least about 5 times more effective than the impurity, at least about 10 times more effective than the impurity, at least about 20 times more effective than the impurity, at least about 50 times more effective than the impurity, at least about 100 times more effective than the impurity, at least about 500 times more effective than the impurity, and/or the like.

According to one embodiment, the step of separating the high-temperature solid from the feedstock may include sinking the high-temperature solid with top-down solidification of the feedstock, such as may remain liquid or be solidified. In the alternative, the step of separating the high-temperature solid from the feedstock may include trapping or collecting the high-temperature solid at a bottom or lower portion of an ingot with bottom-up solidification of the feedstock. The high-temperature solid laden portion of the ingot may be cut or sawed off, such as for recycling, scrap, refining, and/or the like. A further option is to pour off the liquid into another container while being careful to leave the sinking material in the bottom of the container.

According to one embodiment, this invention includes an ingot, a bloom, or a billet made by any of the processes and/or steps disclosed herein. The ingot may be of any suitable size, such as at least about 100 kilograms, at least about 200 kilograms, at least about 300 kilograms, at least about 400 kilograms, at least about 500 kilograms, at least about 750 kilograms, at least about 1,000 kilograms, and/or the like. The ingot may be any suitable quality, such as at least metallurgical grade material, at least solar grade material, at least semiconductor grade material, and/or the like. The ingot may include any suitable concentration of impurities, such as less than about 10 parts per million atomic, less than about 7 parts per million atomic, less than about 5 parts per million atomic, less than about 4 parts per million atomic, less than about 3 parts per million atomic, less than about 2 parts per million atomic, less than about 1 part per million atomic, less than about 0.5 parts per million atomic, less than about 0.1 parts per million atomic, less than about 0.05 parts per million atomic, less than about 0.01 parts per million atomic, and/or the like.

According to one embodiment, this invention may include a process for reducing impurities in silicon suitable for use in solar cells or solar modules. The process may include the step of melting a feedstock with impurities, and the step of reacting the impurities with an impurity-removing agent to form a high-temperature solid. The process may also include the step of separating the high-temperature solid from the feedstock, wherein the high-temperature solid includes a segregation coefficient of at least about 10 times more effective than the impurity

According to one embodiment, this invention may include a process for reducing impurities in silicon suitable for use in solar cells or solar modules. The process may include the step of melting silicon with about 10 parts per million atomic of phosphorous, and the step of adding about 1,000 parts per million atomic of gallium to the silicon. The process may also include the step of reacting the phosphorous with the gallium to form gallium phosphide, and the step of separating the gallium phosphide from at least a portion of the silicon. The process may also include the step of solidifying the silicon and the step of remelting the silicon. The process may also include the step of reducing a content of the gallium in the feedstock, and the step of resolidifying the silicon.

As used herein the terms “having”, “comprising”, and “including” are open and inclusive expressions. Alternately, the term “consisting” is a closed and exclusive expression. Should any ambiguity exist in construing any term in the claims or the specification, the intent of the drafter is toward open and inclusive expressions.

Regarding an order, number, sequence and/or limit of repetition for steps in a method or process, the drafter intends no implied order, number, sequence and/or limit of repetition for the steps to the scope of the invention, unless explicitly provided.

### EXAMPLES

### Comparative Example

A 100 kilogram mass of silicon feedstock with 10 parts per million atomic phosphorus melts in a crucible. No impurity-removing agent is added. Directional solidification is performed four (4) times to reduce the phosphorus concentration to about 1.1 parts per million atomic. The resulting ingot has a usable mass of 40 kilograms (40 percent based on weight) of the original mass of the silicon and the remaining 60 kilograms is scrap.

### Example 1

A 1,000 kilogram mass of silicon feedstock with 10 parts per million atomic phosphorous melts in a crucible as above. 300 parts per million atomic gallium is added as an impurity-removing agent, giving a 30:1 ratio to the phosphorus. The gallium is 99.9 percent pure on an atomic or a molar basis. The gallium reacts with the phosphorous and forms gallium phosphide, a high-temperature solid. During the reaction phase, the melt is stirred to enhance mixing and precipitation. After about 10 to about 30 minutes of stirring, the stirring is stopped and the melt is allowed to settle. The gallium phosphide readily separates to the bottom based on phase separation and/or density differences. The liquid silicon is then decanted into a separate container while leaving the precipitates behind. This is accomplished by pouring the liquid through a silica filter and by leaving behind the last 2 percent (based on weight) of the material. In the separate container, the liquid is directionally solidified from the bottom up. The last 5 percent (based on weight) of the material is poured off before solidifying. At this point, the solid silicon has less than 1 ppma of phosphorus and 10 ppma of gallium. The silicon can possess between 0.65 ppma and 1.20 ppma of boron and be used to make a product with a target resistivity between 1.5 and 0.5 ohm-centimeter, respectively.

The resulting ingot has a usable mass of 930 kilograms (93 percent based on weight) of the original mass of the silicon and the remaining 70 kilograms is scrap. The use of the impurity-removing agent and the high-temperature solid beneficially result in an increase of over 100 percent (based on weight) additional yield than directional solidification alone, and with considerably less processing cost and steps.

### Example 2

A 100 kilogram mass of silicon feedstock with 10 parts per million atomic phosphorous melts in a crucible as above. 1,000 parts per million atomic gallium is added as an impurity-removing agent, giving a 100:1 ratio to the phosphorus. The gallium is 99.9 percent pure on an atomic or a molar basis. The gallium reacts with the phosphorous and forms gallium phosphide, a high-temperature solid. During the reaction phase, the melt is stirred to enhance mixing and precipitation. After about 10 to about 30 minutes of stirring, the stirring is stopped and the melt is allowed to settle. The gallium phosphide readily separates to the bottom based on phase separation and/or density differences. A silicon rod is then brought into contact with the liquid surface, and an ingot is pulled out of the melt. At the end, about 5 percent (based on weight) of the liquid is left in the crucible while the ingot is pulled out of the melt. At this point, the solid silicon has less than 1 ppma of phosphorus and 30 ppma of gallium. The silicon is either sold as-is or melted and directionally solidified one additional time with a greater than 95 percent (based on weight) yield, giving silicon with less than 0.75 ppma of phosphorus and less than 2 ppma of gallium.

The resulting ingot has a usable mass of 90 kilograms (90 percent based on weight) of the original mass of the silicon and the remaining 10 kilograms is scrap. The use of the impurity-removing agent and the high-temperature solid beneficially result in an increase of over 100 percent (based on weight) additional yield than directional solidification alone, and with considerably less processing cost and steps.

It will be apparent to those skilled in the art that various modifications and variations can be made in the disclosed structures and methods without departing from the scope or spirit of the invention. Particularly, descriptions of any one embodiment can be freely combined with descriptions or other embodiments to result in combinations and/or variations of two or more elements or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A process for reducing impurities in silicon suitable for use in solar cells or solar modules, the process comprising:
melting a feedstock with impurities;
adding an impurity-removing agent to the feedstock;
reacting the impurities with the impurity-removing agent to form a high-temperature solid; and
separating the high-temperature solid from the feedstock.

2. The process of claim 1, wherein the high-temperature solid and the molten feedstock have a density ratio of at least about 1:1 to more than about 1.5:1.

3. The process of claim 1, further comprising mixing the feedstock and the impurity-removing agent by bubbling an inert gas, stirring mechanically, agitating electromagnetically, and combinations thereof.

4. The process of claim 1, wherein the impurity comprises boron or phosphorous.

5. The process of claim 1, wherein the impurity comprises a concentration of between about 1 part per million atomic and about 500 parts per million atomic.

6. The process of claim 1, wherein the impurity-removing agent comprises gallium.

7. The process of claim 1, wherein the impurity-removing agent comprises between about 10 parts per million atomic and about 10,000 parts per million atomic of a mixture of the feedstock and the impurity-removing agent.

8. The process of claim 1, wherein the impurity-removing agent comprises about 1,000 parts per million atomic of a mixture of the feedstock and the impurity-removing agent.

9. The process of claim 1, wherein the separating comprises density-based liquid separation.

10. The process of claim 1, further comprising adding a slag-forming agent.

11. The process of claim 10, wherein the slag-forming agent sinks or floats in the feedstock.

12. The process of claim 10, wherein the slag-forming agent comprises silicon dioxide.

13. The process of claim 1, further comprising reducing a content of the impurity-removing agent in the feedstock.

14. The process of claim 1, further comprising:
solidifying the feedstock during or after separating the high-temperature solid;
remelting the feedstock;
optionally reducing a content of the impurity-removing agent in the feedstock; and
resolidifying the feedstock using directional solidification and separating a last-to-freeze material from a remaining portion.

15. The process of claim 1, wherein a ratio of the impurity-removing agent to the impurity comprises at least about 1:1 to about 50:1.

16. The process of claim 1, wherein the high-temperature solid comprise gallium phosphide.

17. The process of claim 1, wherein the high-temperature solid comprises a melting point at least about 50 degrees Celsius greater than a melting point of the feedstock.

18. The process of claim 1, wherein a ratio of the impurities in the feedstock to impurities in a purified feedstock comprises at least about 3:1.

19. The process of claim 1, wherein a mass of purified feedstock comprises at least about 75 percent of a mass of the feedstock with impurities.

20. The process of claim 1, wherein a ratio of segregation coefficients of the impurity to the impurity-removing agent comprises at least about 20:1.

21. The process of claim 1, wherein the impurity-removing agent comprises a segregation coefficient of less than about 0.05.

22. The process of claim 1, wherein the separating the high-temperature solid from the feedstock comprises sinking the high-temperature solid with top-down solidification of the feedstock, or comprises trapping the high-temperature solid at a bottom of an ingot with bottom-up solidification of the feedstock.

23. The process of claim 1, wherein the feedstock comprises at least about 500 kilograms.

24. An ingot made by the process of claim 1.

25. The ingot of claim 24, wherein a concentration of impurities comprises less than about 3 parts per million atomic.

26. A process for reducing impurities in silicon suitable for use in solar cells or solar modules, the process comprising:
melting a feedstock with impurities;
reacting the impurities with an impurity-removing agent to form a high-temperature solid; and
separating the high-temperature solid from the feedstock;
wherein the high-temperature solid comprises a segregation coefficient of at least about 2 times more effective than the impurity.

27. The process of claim 26, wherein the high-temperature solid comprises a segregation coefficient of at least about 100 times more effective than the impurity.

28. A process for reducing impurities in silicon suitable for use in solar cells or solar modules, the process comprising:
melting silicon with about 10 parts per million atomic of phosphorous;
adding about 1,000 parts per million atomic of gallium to the silicon;
reacting the phosphorous with the gallium to form gallium phosphide;
separating the gallium phosphide from at least a portion of the silicon;
solidifying the silicon;
remelting the silicon;
reducing a content of the gallium in the feedstock; and
resolidifying the silicon.

29. An ingot made by the process of claim 28.
